(19) United States
(12) Patent Application Publication
(10) Pub. No.: US 2018/0325127 A1
(43) Pub. Date: Nov. 15, 2018

(54) SURFACE PLASMA TREATMENT AND COATING OF FOOD PRODUCTS

(71) Applicant: Campbell Soup Company, Camden, NJ (US)

(72) Inventor: Reha Onur Azizoglu, Cherry Hill, NJ (US)

(21) Appl. No.: 15/977,363

(22) Filed: May 11, 2018

Related U.S. Application Data
(60) Provisional application No. 62/506,189, filed on May 15, 2017.

(51) Int. Cl. A21D 13/24; A23P 20/10; A23P 20/18

(52) U.S. Cl. CPC A21D 13/24; A23P 20/18; A23P 20/11

(57) ABSTRACT

Embodiments herein include a method for disposing a composition on a food product. The method can include generating an activated gas by introducing a working gas into a plasma chamber and generating nonthermal plasma in the plasma chamber, where the working gas and the nonthermal plasma interact to form an activated gas. The method can include supplying the activated gas to a food treatment zone. Food products can be conveyed through the food treatment zone such that activated gas contacts a surface of the food products. Food products can be conveyed through an application region and a composition is deposited on the surface of the food product. Other embodiments are also included herein.

This application claims the benefit of U.S. Provisional Application No. 62/506,189 filed May 15, 2017, the content of which is herein incorporated by reference in its entirety.

### FIELD

Embodiments herein relate to treating a food product surface. More specifically, embodiments herein relate to applying a composition to a treated food product surface.

### BACKGROUND

As a part of many food manufacturing processes, food objects are commonly coated with compositions (or coating compositions) to enhance organoleptic properties. There is a wide array of foods that can be coated with compositions including, but not limited to, baked goods and fried goods. Exemplary coating compositions can include, but are not limited to, oils and seasonings. Specialized application equipment can be used to apply compositions to food products.

### SUMMARY

Embodiments herein include a method for disposing a composition on a food product. The method includes generating an activated gas. Generating an activated gas includes introducing a working gas into a plasma chamber and generating nonthermal plasma in the plasma chamber, where the working gas and the nonthermal plasma interact to form an activated gas. The method also includes supplying the activated gas to a food treatment zone. Food products are conveyed through the food treatment zone such that activated gas contacts a surface of the food products. Food is conveyed through an application region and a composition is deposited on the surface of the food products.

In an embodiment, a system for applying a composition to a food product comprises an activated gas generator. The activated gas generator comprises a source of a working gas, a nonthermal plasma generator configured to generate a nonthermal plasma, and an activated gas formation chamber for contacting the cold plasma with the working gas where an activated gas is formed. The activated gas formation chamber defines an activated gas outlet. The system includes a food treatment chamber is in fluid communication with the activated gas outlet. The food treatment chamber is configured to receive a food product for treatment with the activated gas. The system includes a composition applicator configured to deposit a composition on a surface of the food product after treatment with the activated gas.

In an embodiment, a system for modifying the surface of a material comprises a gas generator. The gas generator is configured to generate nonthermal plasma in a working gas and provide activated working gas. The system includes a conveying mechanism configured to receive an object, the conveying mechanism including a movable belt surface. The movable belt surface includes a plurality of apertures configured to emit activated gas formed by the gas generator. The system further includes a composition applicator downstream from the conveying mechanism configured to deposit a composition on a surface of the object.

In an embodiment, a system for modifying the surface of a material includes a gas generator. The gas generator is configured to receive a working gas, generate nonthermal plasma, and produce an activated gas. The system includes a tumbler in fluid communication with the gas generator. The tumbler includes a bulk material inlet for receiving a bulk material to be treated, a gas inlet in fluid communication with the gas generator, and a rotational drum configured to receive the activated gas from the gas inlet at a mixing region of the drum. The tumbler further includes a composition applicator configured to introduce a composition into the mixing region of the drum.

In an embodiment, a system for modifying the surface of a material includes a gas generator. The gas generator is configured to generate nonthermal plasma in a working gas and produce an activated gas. The system includes a treatment tunnel in fluid communication with the gas generator. The treatment tunnel is configured to contain a flow of activated gas. The system includes a conveying mechanism configured to move discrete food items through the flow of activated gas in the treatment tunnel. The system further includes a composition applicator downstream from the treatment tunnel. The composition applicator is configured to deposit a composition on the discrete food items.

In an embodiment, a system for modifying the surface of a material includes a gas generator. The gas generator is configured to generate nonthermal plasma in a working gas and provide activated working gas. The system includes a bearing structure configured to support an object, the bearing structure comprising a plurality of apertures. The plurality of apertures is configured to emit activated gas from the gas generator. The system further includes a composition applicator downstream from the conveying mechanism configured to deposit a composition on a surface of the object.

### BRIEF DESCRIPTION OF THE FIGURES

Aspects may be more completely understood in connection with the following drawings, in which:

FIG. 1 is a schematic block diagram of a system for coating an object in accordance with various embodiments herein.

FIG. 2 is a schematic side view of an object coating system in accordance with various embodiments herein.

FIG. 3 is a schematic top view of an object treating system in accordance with various embodiments herein.

FIG. 4 is a schematic side view of an object treating system in accordance with various embodiments herein.

FIG. 5 is a schematic side view of an object treating system in accordance with various embodiments herein.

FIG. 6 is a schematic side view of an activated gas generator in accordance with various embodiments herein.

FIG. 7 is a schematic side view of an object coating system in accordance with various embodiments herein.

FIG. 8 is a depiction of the increased oil pickup enabled in an experimental setup in accordance with various embodiments herein.

FIG. 9 is a block diagram of a method for coating an object in accordance with various embodiments herein.

While embodiments are susceptible to various modifications and alternative forms, specifics thereof have been shown by way of example and drawings, and will be described in detail. It should be understood, however, that the scope herein is not limited to the particular embodiments described. On the contrary, the intention is to cover modifications, equivalents, and alternatives falling within the spirit and scope herein.

### DETAILED DESCRIPTION

There is a wide array of objects that can be coated with a composition as part of a manufacturing process including, but not limited to, food products. Food products can include, but are not limited to crackers, biscuits, cookies, chips, and the like.

As a specific example, food products are commonly coated with oils, particulates, and/or other compositions. Such coatings can be used to enhance the organoleptic properties of the food product and make them more desirable to consumers.

However, in some manufacturing processes, coating a food product necessarily involves over-applying a composition to the product to ensure a sufficient coat (or amount) on desired surfaces of the product. Unfortunately, such practices can lead to a food product that has undesirably high concentrations of the coating material, which may have adverse nutritional effects. Also, in some manufacturing processes, the surface interaction between a food product and a coating results in a poor adhesion of the coating. The low coating efficiency resulting from poor adhesion can lead to wasted coating composition materials and increase the cost of manufacturing food products.

However, embodiments herein can consistently increase the ability of a coating to adhere to a food product and thereby decrease the amount of coating that is necessary to produce a desired product. As such, surface modification systems disclosed herein can provide food products that are cheaper, healthier, and more desirable.

In various embodiments herein, an activated gas is generated and then supplied to a food treatment zone. The activated gas can be generated by introducing a working gas into a plasma chamber and then generating a nonthermal plasma in the plasma chamber or otherwise exposing the working gas to a nonthermal plasma. As such, the working gas and the nonthermal plasma interact to form an activated gas. A food product is conveyed through the food treatment zone such that activated gas contacts a surface of the food product. The food product is then conveyed through an application region where a composition is deposited a composition on the surface of the food product.

In many embodiments herein, the nonthermal plasma does not directly contact the surface of the food product. Rather, the nonthermal plasma contacts a working gas to form an activated gas. Then, the activated gas is conveyed to contact the food product. The average distance between the point of nonthermal plasma generation and point of contact with the food product in the system can vary. In some embodiments, this distance can be at least about 0.5, 1, 2, 5, 10, 20, 30, 50 or more centimeters. In some embodiments, this distance can be in a range wherein any of the foregoing distances can serve as the upper or lower bound of the range, provided that the upper bound is greater than the lower bound.

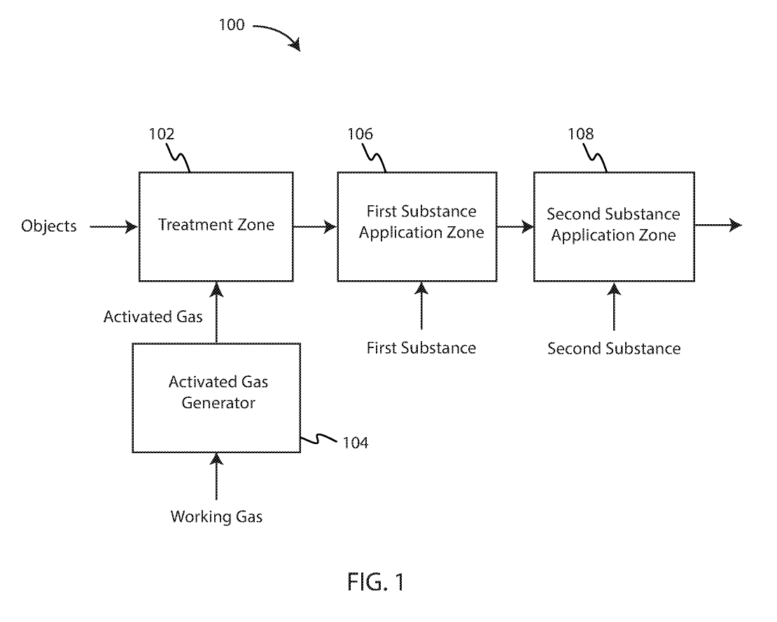

Referring now to FIG. 1, a schematic block diagram is shown of a system for coating an object in accordance with various embodiments herein. The system 100 is generally used perform a surface treatment on a material. In some embodiments, the system 100 can further be used to apply one or more compositions to the treated surfaces of the material. The surface treatment performed by the system 100 can be used to enhance the material's ability to receive a coating. The system 100 generally performs a surface treatment by contacting one or more surfaces of an object with an activated gas. The activated gas used by the system 100 is a gas that has been activated by non-thermal plasma.

The system 100 can be adapted to treat a variety of materials. In some embodiments, the system is configured to treat discrete items. In some embodiments, the system 100 is configured to treat a continuous mass. In some embodiments, the system 100 is configured to treat discrete food items. The various materials that can be treated by the various systems disclosed herein will be described further below. The system 100 can be used to increase the ability of a material to adhere to a coating.

The system 100 can include a treatment zone 102. The treatment zone 102 is a region of the system 100 where objects are contacted by activated gas. The treatment zone 102 can receive objects and activated gas as inputs, and output treated objects. The treatment zone 102 can include a food treatment chamber in fluid communication with an activated gas generator. The activated gas is in contact with the objects for residence time sufficient to modify the surface of the objects to a desired degree. The treatment zone 102 can be used to increase the surface energy of an object. The treatment zone 102 can be used to increase the wettability of an object. Various aspects of the surface modification will be discussed further herein. The treatment zone 102 can include a variety of structures for receiving objects, conveying objects, receiving activated gas, contacting objects with the activated gas, and discharging treated objects. Such structures will be described further below.

The activated gas used to treat objects in the treatment zone 102 can be produced by an activated gas generator 104. The activated gas generator is generally used to provide an activated gas. The activated gas generator can receive a working gas and output an activated gas. The activated gas generator can generate an activated gas by generating non-thermal plasma within a volume of working gas, or by otherwise contacting or interacting a non-thermal plasma and a working gas. Various methods of generating non-thermal plasma, such as dielectric barrier discharge, can be implemented by the activated gas generator 104, as will be described further below. A variety of working gasses can be used, and the composition of the activated gas produced by introducing non-thermal plasma within the working gas can depend on the composition of the working gas. In some embodiments, ambient air is used as a working gas. However, other gases can also be used as the working gas. Various reactive species can be produced within the working gas as a result of non-thermal plasma activation. Various details of the working gas and activated gas produced therefrom will be described further herein.

The system 100 can include a first composition application zone 106 for applying a first composition to objects. Various compositions can be applied to objects at a first composition application zone 106. In some embodiments, the first composition application zone 106 applies a food-grade oil to food objects. The system 100 can also include a second composition application zone 108 for applying a second composition to objects. Various compositions can be applied to objects at a second composition application zone 108. In some embodiments, the second composition application zone 108 applies a particulate-based seasoning to food objects. Various methods of applying a composition can be used, as will be described further herein.

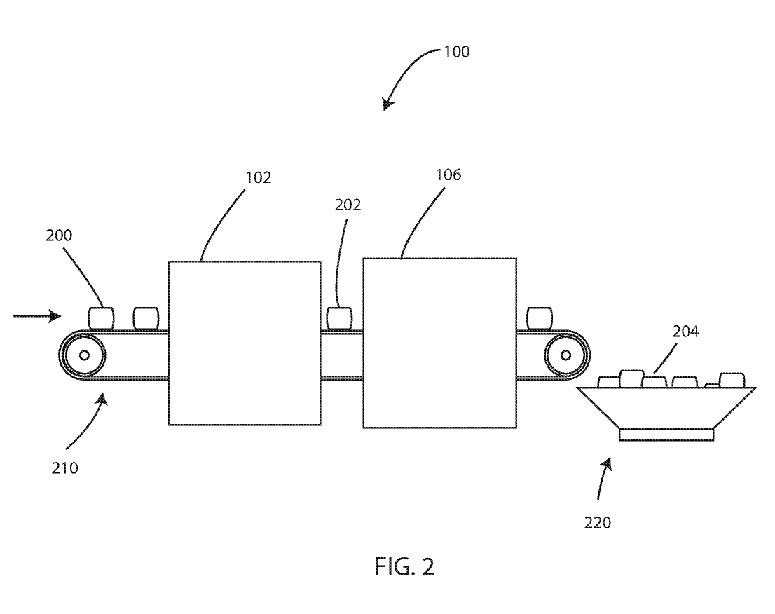

Referring now to FIG. 2, a schematic side view is shown of an object coating system in accordance with various embodiments herein. The coating system can have a function consistent with the systems described above with reference to FIG. 1. A coating system generally applies a coating composition to an object after the object has undergone a surface treatment. The coating system 100 is used to treat and apply a composition to objects 200. The objects 200 can be carried through the system 100 by a conveying mechanism 210. The conveying mechanism 210 can include a movable belt surface for receiving and conveying the objects 200. The coating system 100 includes a treatment zone 102. The treatment zone 102 receives untreated objects 200 and outputs treated objects 202 having a surface treatment. The coating system 100 includes a composition application zone 106. The composition application zone 106 can include a composition applicator for depositing a coating composition on an object. The composition application zone 106 receives treated objects 202 and outputs coated objects 204 having one or more compositions applied thereto. Coated objects 204 can be conveyed to a downstream process 220 for further processing or packaging.

While the objects 200 in FIG. 2 are depicted as a single file line of objects, it will be appreciated that this is by way of illustration and that embodiments herein can include also multiple objects being treated at more or less the same time as part of a plurality of objects moving along through the system simultaneously.

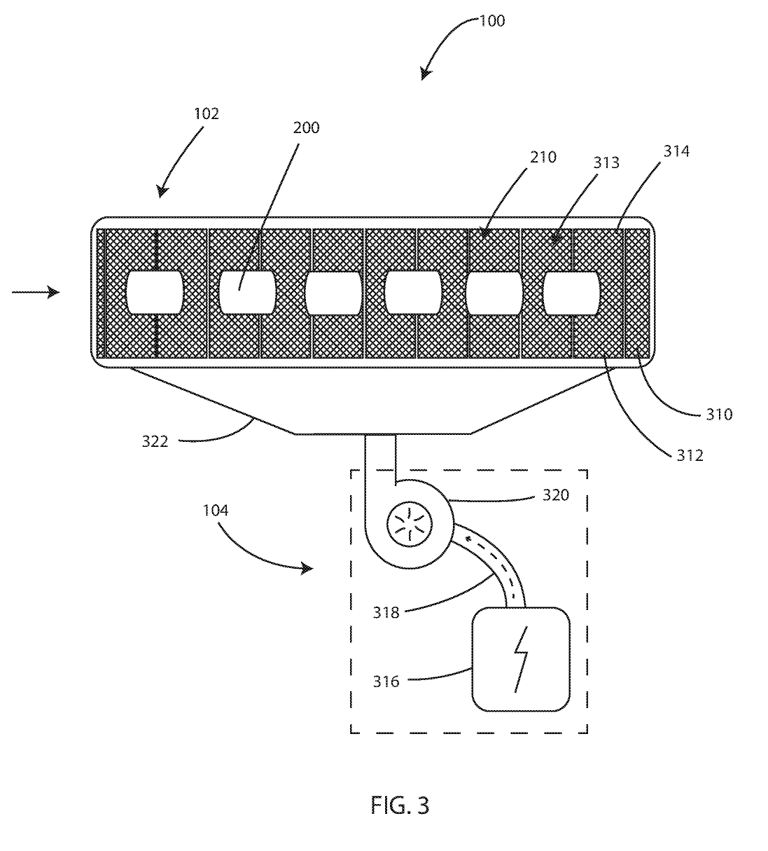

Referring now to FIG. 3, a schematic top view is shown of an object treating system in accordance with various embodiments herein. The treating system 100 is used to treat the surfaces of objects 200. The treating system 100 can be used to continuously treat objects 200. The treating system 100 includes a treatment zone 102 for treating objects 200 with an activated gas. The treatment zone 102 is configured to continuously convey objects 200 through an activated gas environment to continuously treat the objects 200. The treating system 100 can be a part of an object coating system in which objects treated by the treating system 100 are subsequently coated with one or more compositions.

The treatment time (e.g., amount of time during which the objects are exposed to an activated gas) can vary. In some embodiments the treatment time can be at least about 0.5, 1, 2, 3, 5, 7, 10, 15, 20, 30, 45, 60, 120 or 180 seconds. In some embodiments, the treatment time can be in a range wherein any of the foregoing amounts of time can serve as the upper or lower bound of the range.

The treatment zone 102 is configured as a fluidized bed mechanism, where activated gas is passed through one or more objects 200 from underneath the objects. A fluidized bed mechanism can have a substrate surface defining apertures through which activated gas is pushed or otherwise emitted. The treatment zone 102 can be used to contact substantially all of the outside surfaces of objects 200 with activated gas. The treatment zone 102 has a bearing structure 312 for supporting objects 200 as they are moved through the system 100. The bearing structure 312 includes a surface for receiving and carrying objects 200. The surface of the bearing structure 312 includes one or more regions for emitting activated gas. The bearing structure 312 is configured to emit activated gas around objects 200 that are carried thereon such that the objects are contacted by the activated gas. In some embodiments, the bearing structure 312 includes a plurality of apertures 314 for emitting gas. The apertures 314 are in communication with an upstream gas generator for generating the activated gas.

In some embodiments, the bearing structure 312 is a static structure for holding objects 200 and emitting activated gas. In such embodiments, objects can be continuously moved through the treatment zone 102 by way of gravity, dynamic pressure, or an external conveying mechanism. In some embodiments, the bearing structure 312 is a movable structure configured to continuously move objects 200 through the treatment zone 102 while they are treated by activated gas. In some embodiments, the bearing structure 312 is a part of a conveying mechanism. The system 100 depicted in FIG. 3 includes a conveying mechanism 210, the conveying mechanism having a permeable conveyor belt 310 defining the bearing surface 313. The bearing surface 313 of the permeable conveyor belt 310 emits activated gas around the objects 200 while they are conveyed.

The activated gas emitted by apertures 314 of the permeable conveyor belt 310 is generated by an activated gas generator 104. The activated gas generator 104 can be consistent with the various activated gas generators described above with reference to FIG. 1. The activated gas generator 104 is in fluid communication with the plurality of apertures 314 and provides activated gas to the treatment zone 102. The activated gas generator 104 can provide activated gas to a manifold 322. The manifold 322 is generally configured to distribute activated gas to the underside of the bearing surface 313. The manifold 322 can include a sliding seal interface with the permeable conveyor belt 310 to limit the amount of activated gas that bypasses the permeable conveyor belt 310.

The gas generator 104 includes a plasma chamber 316. The plasma chamber 316 is a region of the activated gas generator 104 where non-thermal plasma is generated. Non-thermal plasma is generated within a working gas in the plasma chamber 316. The formation of non-thermal plasma within the plasma chamber 316 activates the working gas such that an activated gas is formed. A working gas can continuously flow through the plasma chamber 316 such that activated gas is continuously produced. The activated gas produced by the plasma chamber can be routed to downstream locations through a conduit 318.

The treatment system 100 includes a pressure source for pumping the activated gas from the activated gas generator 104 into the treatment zone 102. In some embodiments, a pump is employed by the activated gas generator 104 for moving gas through the generator and into the treatment zone 102. The activated gas generator 104 depicted in FIG. 3 includes a pump 320 for pumping activated gas through the system 100. The pump 320 can be located downstream of the plasma chamber 316 and interact with activated gas. In some embodiments, the pump 320 is located upstream of the plasma chamber 316 and interacts with non-activated working gas. The location of the pump 320 is not intended to be limiting. In some embodiments, a pump is located remotely from the system 100, and working gas is provided to the activated gas generator 104 at a pressure sufficient to move the gas through the system at a desired rate.

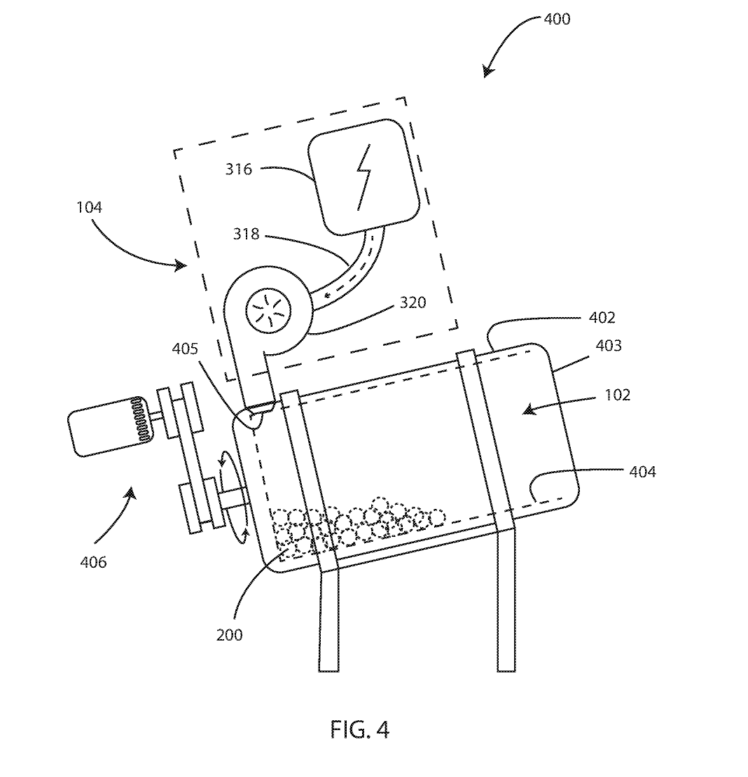

Referring now to FIG. 4, a schematic side view is shown of an object treating tumbler in accordance with various embodiments herein. The treating tumbler 400 is an object treating system and is used to treat the surfaces of objects 200. The treating tumbler 400 includes a treatment zone 102 for treating the objects 200 with an activated gas. The treating tumbler 400 is configured to expose the objects 200 to an activated gas environment for a certain duration. The treating tumbler 400 can be used to treat substantially all of the outside surfaces of objects 200 with activated gas. In some embodiments, the treating tumbler 400 is configured to process a batch of objects 200. In some embodiments, the treating tumbler 400 is configured to process a continuous stream of objects 200.

The treating tumbler 400 depicted in FIG. 4 is configured as a tumbler, and includes a rotational drum 402. The drum 402 forms an inner cavity 404 defining the treatment zone 102. Objects 200 are positioned inside the cavity 404 for treatment in continuous or batch processing. The drum 402 can define a bulk material inlet 403 in communication with the cavity 404 for receiving objects or other bulk materials. The surface of the cavity 404 includes one or more regions for emitting activated gas. The drum 402 is configured to emit activated gas around objects 200 that are placed within the treatment zone 102 such that the objects are contacted by the activated gas. The drum 402 has a gas inlet 405 in communication with a gas generator for generating and providing the activated gas to be used in the treating tumbler 400. In some embodiments, the gas inlet 405 includes a plurality of apertures for emitting activated gas. In some embodiments, the gas inlet 405 includes a port for emitting activated gas.

Activated gas is provided to the treating tumbler 400 by an activated gas generator 104. The activated gas generator 104 is functionally consistent with the various activated gas generators described herein. As such, the activated gas generator 104 can include a plasma chamber 316, a conduit 318, and a pump 320. The activated gas generator is generally in fluid communication with the inner cavity 404. The activated gas provided by the activated gas generator can be introduced into the inner cavity 404 continuously or intermittently. The drum 402 can include a manifold structure for interfacing the inner cavity 404 of the drum 402 with the activated gas generator 104 by way of the gas inlet 405 such that fluid communication is allowed there between.

The drum 402 can rotate as objects 200 are treated with activated gas. The drum can be configured to mechanically tumble objects 200 within an activated gas environment such that the surfaces of the objects are sufficiently contacted with activated gas. The drum 402 can include various structures for mechanically interacting with objects 200 as they are tumbled within the inner cavity 404, such as paddles or agitators. The treating tumbler 400 includes a drive mechanism 406 for effecting rotation of the drum 402. The drive mechanism 406 can be configured to rotate the drum at a constant or varying speed. The drive mechanism 406 provide adjustable speed settings to accommodate various types of objects or treatments.

In addition to tumbling objects within an activated gas environment, the treating tumbler 400 can be used to mix objects with a coating composition. The inner cavity 404 can function as a mixing chamber during rotation. For example, the treating tumbler 400 can be used to mix food items with a seasoning material. In some embodiments, the treating tumbler 400 is configured as a seasoning tumbler. A coating composition can be introduced into the inner cavity 404 once the objects 200 have been treated to the extent that they possess desired surface properties. In some embodiments, a coating composition is introduced into the inner cavity 404 following the activated gas treatment of the objects 200. In some embodiments, a coating composition is introduced into the inner cavity 404 during the activated gas treatment of the objects 200. Various methods of introducing a coating composition into the inner cavity 404 are possible. In some embodiments, a coating composition is manually introduced into the inner cavity 404, such as by dumping through the bulk material inlet 403 of the drum 402. In some embodiments, a coating composition is automatically introduced into the inner cavity 404, such as with a composition applicator. The treating tumbler 400 can include an application mechanism (not shown in this figure) for applying a composition to the objects 200 contained within the inner cavity 404. An application mechanism can provide a composition to the interior of the drum 402 while it is rotated or while it is static. Various details of application mechanisms will be described further herein. In some embodiments, the treating tumbler 400 is configured to apply more than one coating compositions to objects treated thereby. In some embodiments, objects treated by the tumbler-type treatment system 100 are coated at a downstream process.

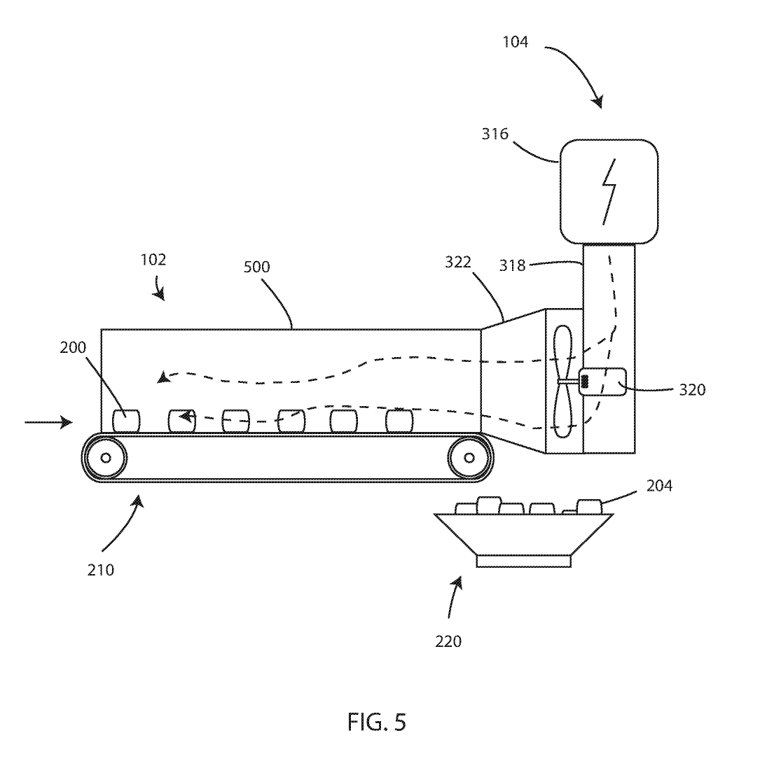

Referring now to FIG. 5, a schematic side view is shown of an object treating system in accordance with various embodiments herein. The treating system 100 is used to treat the surfaces of objects 200. The treating system 100 includes a treatment zone 102 for treating the objects 200 with an activated gas. The treating system 100 is configured to expose the objects 200 to an activated gas environment for a certain duration. In some embodiments, the treating system 100 is configured to process a batch of objects 200. In some embodiments, the treating system is configured to process a continuous stream of objects 200. The treating system 100 can be a part of an object coating system in which objects treated by the treating system 100 are subsequently coated with one or more compositions.

The treating system 100 depicted in FIG. 5 is configured as a treatment tunnel, and includes a tunnel 500. The tunnel 500 is generally a cavity through which the objects 200 can be conveyed and treated. The tunnel 500 is configured to contain a flow of activated gas through which the objects 200 are conveyed. The tunnel 500 can have a geometry for ducting activated gas through and around the objects 200 such that contact is made between the activated air and the surfaces of the objects 200. The treating system 100 can include a conveying mechanism 210 for conveying the objects 200 through the tunnel 500. The tunnel 500 can have an outlet for providing treated objects 202 to a downstream process 220. A downstream process can include a composition applicator located downstream from the treatment tunnel configured to deposit a composition on treated objects.

Activated air is provided to the tunnel 500 by an activated gas generator 104. The activated gas generator 104 can function consistently with the various activated gas generators described herein. As such, the activated gas generator 104 can include a plasma chamber 316, a conduit 318, and a pump 320. The tunnel 500 includes a manifold 322 for interfacing the interior of the tunnel 500 with the activated gas generator 104 such that fluid communication is allowed there between.

### Activated Gas Generators

Various methods can be used to create the activated gas for treating objects. The activated gas generators employed by the various systems herein can include a source of working gas and a mechanism for generating non-thermal plasma. A non-thermal plasma generator can be configured to generate a non-thermal plasma within the working gas. A non-thermal plasma generator can be configured to generate a non-thermal plasma that is contacted by the working gas. The terms “non-thermal plasma” or “nonthermal plasma” referred to herein can mean any cold or non-thermal plasma which is not in thermodynamic equilibrium. Non-thermal plasma can have a temperature near to the temperature of an ambient environment. For example, non-thermal plasma can have a temperature close to room temperature. Non-thermal plasma can have a temperature less than about 100 degrees Celsius. Non-thermal plasma can occur at a pressure nearing atmospheric pressure. Non-thermal plasma can be composed of positive ions, negative ions, electrons, neutral atoms or molecules, excited atoms or molecules, radicals, and ultraviolet photons. Non-thermal plasma can have a net electric charge of zero. US Patent Application Publication 2016/0193373 describes various aspects of non-thermal plasma, and is herein incorporated by reference.

Various techniques can be used for generating non-thermal plasma. The activated gas generators detailed herein facilitate the production of cold plasma by way of dielectric barrier discharge (“DBD”), however other techniques can also be used. Examples of other non-thermal plasma generation types include plasma jet, corona discharge, gliding arc, resistive barrier discharge, and the like. For dielectric barrier discharge, typically there are at least two electrodes (a high voltage electrode and a ground electrode) and a dielectric barrier between the two electrodes. In some cases the dielectric barrier covers at least one of the electrodes. In some cases, both electrodes are covered by dielectric barriers. The supplied electrical energy creates an electrical discharge between the two electrodes.

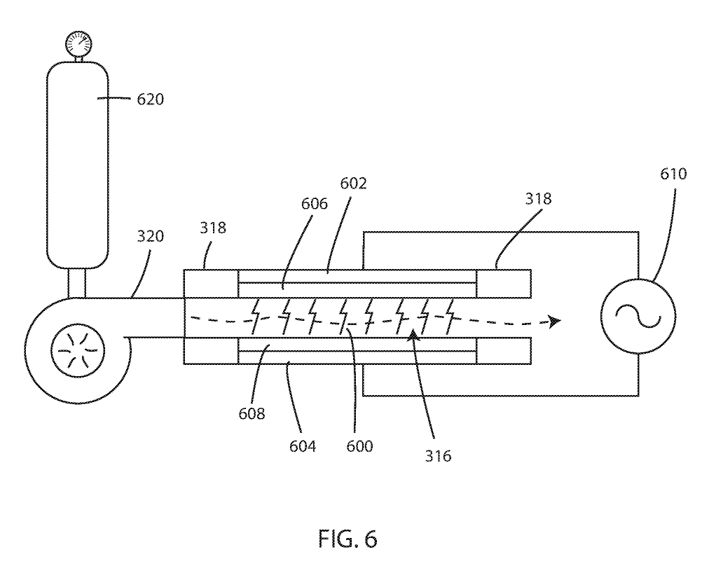

Referring now to FIG. 6, a schematic side view is shown of an activated gas generator in accordance with various embodiments herein. The activated gas generator 104 is an exemplary gas generator that can be employed by the various treatment systems herein. The activated gas generator 104 includes a plasma chamber 316 for generating a non-thermal plasma using dielectric barrier discharge. The activated gas generator 104 can include a current source 610 or generator. The current source 610 can be connected to a high voltage electrode 602 and a ground electrode 604. A dielectric layer 606 can cover the high voltage electrode 602 and a dielectric layer 608 can cover the ground electrode 604. Optionally, one or both of the dielectric layers can be omitted in some scenarios.

Current is provided to the electrodes at a sufficient voltage and frequency such non-thermal plasma is formed between the electrodes. The nature of the supplied current depends on the plasma generating technique employed. In many cases the supplied current is an alternating electric current (“AC”). AC current can have various waveforms such as sinusoidal waveform, a square waveform, a triangular waveform, a sawtooth waveform, a rectangular waveform, and the like. However, in some cases the current can be direct electric current (“DC”), such as if a semiconductor layer of gallium arsenide is used to replace the dielectric layer.

Current can be supplied at various frequencies. The frequency can be from about 0 Hz to 100 Hz. The frequency can be from about 1 Hz to 1 kHz. The frequency can be from about 1 kHz to 10 kHz. The frequency can be from about 10 kHz to 20 kHz. The frequency can be from about 20 kHz to 100 kHz. The frequency can be from about 100 kHz to 1 MHz. The frequency can be from about 1 MHz to 100 MHz. The frequency can be from about 100 MHz to 1 GHz. The frequency can be from about 1 GHz to 100 GHz. The frequency can be greater than about 100 GHz.

Current can be supplied at a voltage. The voltage can be from about 0 V to 10 V. The voltage can be from about 10 V to 100 V. The voltage can be from about 100 V to 1 kV. The voltage can be from about 1 kV to 5 kV. The voltage can be from about 5 kV to 10 kV. The voltage can be from about 10 V to 20 kV. The voltage can be from about 20 kV to 100 kV. The voltage can be greater than about 100 kV. In some embodiments, the voltage is from about 10 kV to 50 kV. In some embodiments, the voltage is from about 25 kV to 40 kV. The above voltages can refer to peak current amplitudes, DC voltages, RMS voltages, and other measures of electric potential of an electric current.

An activated gas generator can have an activated gas outlet. An activated gas outlet can be defined by a conduit. The activated gas generator 104 includes conduits 318 for ducting the flow of working gas into the plasma generating chamber 316 and ducting the flow of activated gas out of the plasma generating chamber and to downstream processes. The activated gas generator 104 can include a source 620 of a working gas. The source 620 can include any supply line, reservoir, and the like that is capable of delivering the desired working gas to gas generator 104. In some embodiments, the source 620 is a reservoir of compressed gas. In some embodiments, the source 620 is a supply tap from a central gas delivery system. In some embodiments, the source 620 is a port for receiving ambient atmospheric air. The source 620 can include filter medias, adsorbents, and other devices for removing unwanted contaminants from the working gas. A pump 320 can be incorporated by the activated gas generator 104 to provide energy to the flow of working and activated working gas.

A variety of working gasses can be used by an activated gas generator to provide activated gas. In some embodiments, a working gas comprises an inert gas. In some embodiments, a working gas comprises at least one of air, argon, helium, nitrogen, combinations thereof, and the like. In some embodiments, air is used as a working gas. In some embodiments, atmospheric air sourced from an ambient environment is used as a working gas. Non-thermal plasma occurring in air can be characterized by the presence of one or more reactive species. In some embodiments, activated gas created by generating non-thermal plasma in air is characterized by a relatively high concentration of reactive species. Reactive species can include, but are not limited to, reactive oxygen species and reactive nitrogen species. Specifically, reactive species can include ozone, hydroxide radicals, nitrogen oxides, and the like. The activated gas produced by the activated gas generator has a composition that reacts with the surface of an object to impart the desired treatment to the object.

The amount of time that the working gas is exposed to the non-thermal plasma can vary. In some embodiments, the working gas is exposed to the non-thermal plasma for at least about 0.5, 1, 2, 3, 5, 7.5, 10, 15, 20, 30, 45, 60, 120, or 180 seconds. In some embodiments, the working gas can be exposed to the non-thermal plasma for a time that is a range wherein any of the foregoing amounts of time can serve as the upper or lower bound of the range, provided that the upper bound is greater than the lower bound.

In some embodiments, a working gas provided to an activated gas generator has a temperature within a range, wherein the upper and lower bounds of the range can be defined by any combination of the following temperatures: −15 degrees Celsius, −10 degrees Celsius, −5 degrees Celsius, 0 degrees Celsius, 5 degrees Celsius, 10 degrees Celsius, 15 degrees Celsius, 20 degrees Celsius, 25 degrees Celsius, 30 degrees Celsius, 35 degrees Celsius, 40 degrees Celsius, 45 degrees Celsius, 50 degrees Celsius, 55 degrees Celsius, 60 degrees Celsius, 65 degrees Celsius, 70 degrees Celsius, 75 degrees Celsius, 80 degrees Celsius, 85 degrees Celsius, 90 degrees Celsius, 95 degrees Celsius, 100 degrees Celsius, 105 degrees Celsius, and 200 degrees Celsius. In some embodiments, a working gas provided to an activated gas generator has a relative humidity within a range, wherein the upper and lower bounds of the range can be defined by any combination of the following relative humidity values: 0 percent, 5 percent, 10 percent, 15 percent, 20 percent, 25 percent, 30 percent, 35 percent, 40 percent, 45 percent, 50 percent, 55 percent, 60 percent, 65 percent, 70 percent, 75 percent, 80 percent, 85 percent, 90 percent, 95 percent, or 100 percent.

In some embodiments, an activated gas provided to a treatment system has a temperature within a range, wherein the upper and lower bounds of the range can be defined by any combination of the following temperatures: −15 degrees Celsius, −10 degrees Celsius, −5 degrees Celsius, 0 degrees Celsius, 5 degrees Celsius, 10 degrees Celsius, 15 degrees Celsius, 20 degrees Celsius, 25 degrees Celsius, 30 degrees Celsius, 35 degrees Celsius, 40 degrees Celsius, 45 degrees Celsius, 50 degrees Celsius, 55 degrees Celsius, 60 degrees Celsius, 65 degrees Celsius, 70 degrees Celsius, 75 degrees Celsius, 80 degrees Celsius, 85 degrees Celsius, 90 degrees Celsius, 95 degrees Celsius, 100 degrees Celsius, 105 degrees Celsius, and 200 degrees Celsius. In some embodiments, an activated gas provided to a treatment system has a relative humidity within a range, wherein the upper and lower bounds of the range can be defined by any combination of the following relative humidity values: 0 percent, 5 percent, 10 percent, 15 percent, 20 percent, 25 percent, 30 percent, 35 percent, 40 percent, 45 percent, 50 percent, 55 percent, 60 percent, 65 percent, 70 percent, 75 percent, 80 percent, 85 percent, 90 percent, 95 percent, or 100 percent.

### Objects Treated

A variety of materials and objects can be treated by the systems disclosed herein. The objects treated by the systems disclosed herein are generally objects requiring a surface modification that can be provided by an activated gas. The objects can comprise food products. As used herein, the term “food product” shall include foods of all types, unless used explicitly to the contrary. Food products are comestible items safe for human or animal consumption and can include human food products, pet food products, geriatric food products, food products for at-risk populations, baby food products, nutraceuticals, and the like. Food products can include baked goods such as crackers, biscuits, breads, chips, cookies, and the like. Food products can include fried goods such as fries, breads, chips, and other fried foods. Other food products can include, but are not limited to, nut products, grain products, pasta products, food components or ingredients, dairy products, meat products, fish products, entrees, combinations of any of these, and the like. Food products can include discrete food items. Continuous food items can also be treated by the various systems disclosed herein.

The various products treated by the treating and coating systems disclosed herein can have various properties. In some embodiments, a material or object is at least partially gas-permeable. An activated gas can penetrate a gas-permeable material and cause a surface treatment within a treatment depth of the outer surface of the material. In some embodiments, an object is substantially gas-impermeable. In such embodiments, an activated gas only causes a surface treatment on the outer surface of the material. The residence time of a material within an activated gas environment can be adjusted to provide a desired magnitude and treatment depth of a surface treatment. Similarly, the concentration of activated gas within a treatment zone or system can be adjusted to provide a desired magnitude and treatment depth of a surface treatment.

The amount of time that a material is exposed to an activated gas can vary. In some embodiments, a material is exposed to the activated gas for a residence time of at least about 0.1, 0.5, 1, 2, 3, 5, 7.5, 10, 15, 20, 30, 45, 60, 120, 180, 240, 300, 360, 420, 480, or 540 seconds. In some embodiments, the working gas can be exposed to the non-thermal plasma for a time that is a range wherein any of the foregoing amounts of time can serve as the upper or lower bound of the range, provided that the upper bound is greater than the lower bound. In some embodiments, a material is exposed to the activated gas for a residence time of greater than about 540 seconds.

In some embodiments herein, the surface energy of at least one surface of the food objects can be changed as a result of exposure to the activated gas. By way of example, the surface energy of at least one surface can be changed by at least about 0.1, 0.2, 0.5, 1.0, 1.5, 2.0, 2.5, 3, 5, 7.5, 10, 12.5, 15 or 20 dynes/cm. In some embodiments, the surface energy can be changed by an amount that is in a range wherein any of the foregoing surface energy amounts can serve as the upper or lower bound of the range, provided that the upper bound is greater than the lower bound.

### Coatings and Application Thereof

A variety of compositions can be applied to objects as a coating by the systems disclosed herein. As used herein, the terms “coat” and “coating” can refer to any amount of composition disposed on the surface of an object. A coat or coating can include a layer or film completely covering one or more surfaces of an object. A coat or coating can include a layer or film less than completely covering one or more surfaces of an object. A coat or coating can include an encapsulating film. A coat or coating can include the application of particles or seasonings at intermittent spaced locations around a surface of an object. A “coating composition” as used herein can refer to any matter that is applied or otherwise disposed on the surface of an object as a coat or coating, unless the context clearly indicates otherwise.

Example coating compositions include oils, colorants, flavorings, pharmaceutical compositions, and the like. In some embodiments, a coating composition includes a comestible oil. Comestible oils can include oils derived from animals or plants. Comestible oils include, but are not limited to, olive oil, sunflower oil, vegetable oil, canola oil, peanut oil, palm oil, coconut oil, corn oil, rendered animal fats, and the like. In some embodiments, non-comestible oils are used as a coating composition. Non-comestible oils can include various mineral oil products and derivatives.

Coating compositions can further include various solid materials such as comestible seasonings. Comestible seasonings can include, but are not limited to, edible salts, cheese flavorings, peppercorn solids, vegetable solids, fruit solids, meat solids, spices, natural flavorings, artificial flavorings, preservatives, and the like. Other coating compositions can include pharmacologically active particulates, colorings agents, and other compositions required by an object. In some embodiments, coating compositions can specifically include hydrophobic materials. In some embodiments, coating compositions can include hydrophilic materials.

Various methods and mechanisms can be used to apply coating compositions to materials in the systems disclosed herein. Compositions can be applied by a sprayer, enrober, dip tank, tumbler, and the like. Compositions can be applied to objects at a location downstream from a treatment zone of a treating system. Mechanisms for applying a composition can be integrated with a treating system or can be remote from a treating system. In some embodiments, such as the tumbler systems described above with reference to FIG. 4, a composition application occurs in the same region of as system as the surface treatment occurs.

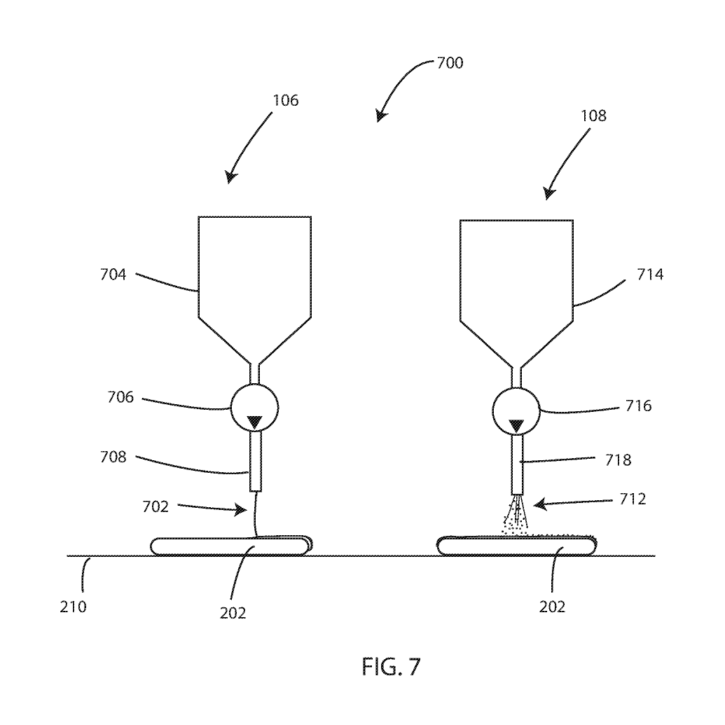

Referring now to FIG. 7, a schematic side view is shown of an object coating system in accordance with various embodiments herein. The coating system 700 can apply a first composition 702 and a second composition 712. Alternative coating systems can be used that apply only one composition or that apply more than two compositions. Further, alternative coating system types can be used that apply multiple compositions. The coating system 700 is configured to apply compositions to treated objects 202 or other treated materials. The treated objects 202 are objects having been treated by any of the various treatment systems disclosed herein. In particular, the treated objects 202 can be objects that have undergone a treatment by the various systems disclosed herein such that the treated objects 202 have an increased surface energy or other characteristic enhancing their coatability.

The coating system 700 can include a first application zone 106 for applying the first coating composition 702. The coating system 700 can include a second application zone 108 for applying the second coating composition 712. The coating system 700 can include a conveying mechanism 210 for moving treated objects 202 through the first application zone 106 and the second application zone 108. For purposes of illustration, the particular coating system 700 depicted in FIG. 7 is shown to coat a top surface of the treated objects 202, but other configurations are possible wherein the entirety of the surface of treated objects can be coated. Similarly, alternative configurations exist wherein other partial or complete surfaces are subjected to a coating within a single pass of the system.

The first application zone 106 includes a first source 704 for providing a first composition 702. The first application zone 106 can include a first pumping mechanism 706 configured to move the first composition 702 from the first source 704. The first pumping mechanism 706 can provide the first composition 702 to a first nozzle 708. Likewise, the second application zone 108 includes a second source 714 for providing a second composition 712. The second application zone 108 can include a second pumping mechanism 716 configured to move the second composition 712 from the second source 714. The second pumping mechanism 716 can provide the second composition 712 to a second nozzle 718.

The sources used by application zone 106 can include tanks, hoppers, supply conduits, or other sources of their respective compositions. The compositions can be various fluids or particles contained within a fluid medium. The sources can include mechanisms for providing a uniform and consistent product. The pumping mechanism can include various pumping structures for pumping the composition to be applied. Liquid compositions can be pumped by liquid pumps, Solid fluids can be pumped with pumps suitable for pumping solid materials. Some systems are absent a pump, and flow of compositions is provided by gravity or another pressure source. In some embodiments, a pump is configured as a sprayer wherein a gaseous or liquid carrier is configured to transport a solid or liquid composition, such as a pneumatic sprayer. The pumping mechanisms disclosed herein are not intended to be limiting. The nozzles are configured to work in combination with the sources and the pumping mechanisms to provide their respective compositions in a desired manner. In some embodiments, a nozzle is configured to emit a continuous curtain of a composition. In some embodiments, a nozzle is configured to emit a spray of aerosols or other particulate.

In some coating systems, the first application zone can be configured to apply a substantially continuous layer of edible oil to a cracker. The cracker is conveyed through a curtain of oil, and the oil adheres to the cracker. At the second treatment zone, a coat of seasoning can be applied to an oil-coated cracker. The seasoning can be a solid particulate transported by a gaseous carrier. In some embodiments, the gaseous carrier can itself be an activated gas as described herein. In other embodiments, the gaseous carrier is not an activated gas as described herein. The seasoning particles can adhere to the oil layer of the cracker.

### Throughput Rate

A treating system can be configured to treat or treat and coat objects with at a certain throughput rate. In some embodiments, a treating system has a throughput rate within a range, wherein the upper and lower bounds of the range can be defined by any combination of the following throughput rates: 1 object per minute, 25 objects per minute, 50 objects per minute, 100 objects per minute, 150 objects per minute, 200 objects per minute, 200 objects per minute, 300 objects per minute, 400 objects per minute, 500 objects per minute, 750 objects per minute, 1000 objects per minute, 1500 objects per minute, 2000 objects per minute, 2500 objects per minute, 3000 objects per minute, 4000 objects per minute, or 5000 objects per minute.

### Methods

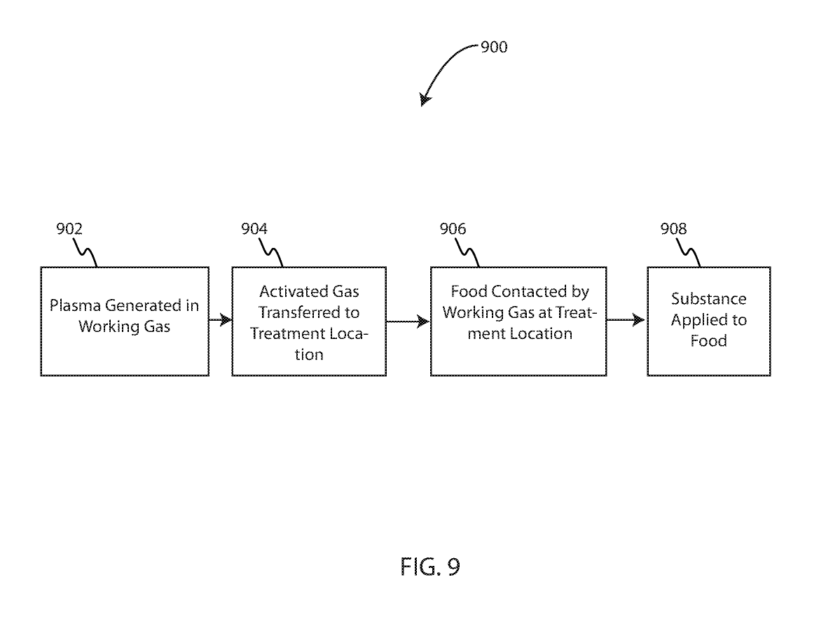

Referring now to FIG. 9, a block diagram is shown of a method for coating an object in accordance with various embodiments herein. The method 900 can be performed by the various object treatment systems disclosed herein. The method 900 can produce a product having modified surface characteristics. In some embodiments, the method 900 involves coating an object, the object having modified surface characteristics. The surface of an object can be treated such that it has an increased surface energy.

The method 900 includes generating plasma in a working gas 902. The plasma generation 902 can be undergone in an activated gas generator. Plasma generation 902 generally produces an activated gas from a working gas. For example, working gas can be introduced into a plasma chamber and a nonthermal plasma can be generated in the plasma chamber such that the working gas and the nonthermal plasma interact to form an activated gas. The activated gas is then supplied 904 to a treatment location. For example, an activated gas can be supplied to a food treatment zone. The treatment location can be consistent with those described herein. At the treatment location, food is contacted 906 by the working gas. The food can be contacted for a period of time sufficient to impart the desired characteristics on the surface of the food. For example, a food product can be conveyed through a food treatment zone such that activated gas contacts a surface of the food product. After treatment, a composition is applied 908 to the surface of the food. The composition can be applied by a composition applicator at a composition application zone consistent with those described herein. For example, a food product can be conveyed through an application region or other composition applicator where a composition is deposited on the surface of the food product.

### EXAMPLES

### Example 1: Oil Pickup of Treated Crackers

Crackers (pretzel-type wheat-based dough cracker) were manufactured and divided into two groups (control and experimental). The control group of crackers was exposed to a control condition that included exposure to a food grade oil spray without any prior exposure to an activated gas. The experimental group of crackers was exposed to an activated gas for a total contact time of about 2 minutes. The activated gas was generated from a working gas comprising air using a plasma jet at 134V, 3.1 Amp and 19.9 kHz.

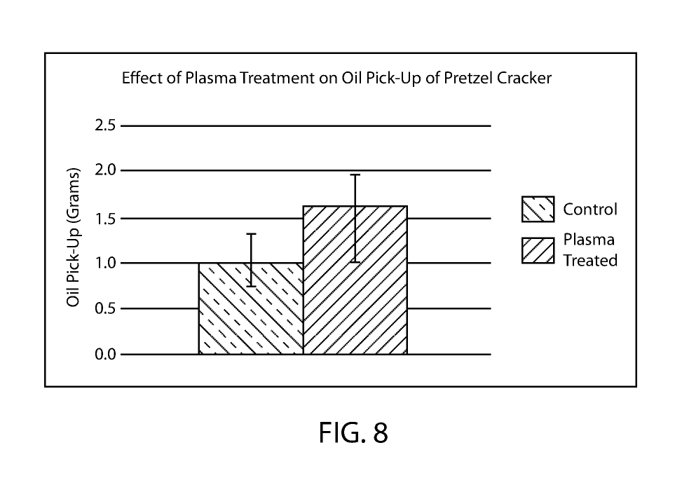

The results are shown in FIG. 8, which depicts increased oil pickup for the experimental crackers. In specific, FIG. 8 shows an increased oil pickup rate for pretzel crackers that were treated with nonthermal plasma activated air compared to pretzel crackers that were not treated with non-thermal plasma activated air.

The embodiments described herein are not intended to be exhaustive or to limit the invention to the precise forms disclosed in the following detailed description. Rather, the embodiments are chosen and described so that others skilled in the art can appreciate and understand the principles and practices. Therefore, it should be understood that many variations and modifications may be made while remaining within the spirit and scope herein.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

1. A method for disposing a composition on a food product comprising:
generating an activated gas comprising:
introducing a working gas into a plasma chamber, and
generating nonthermal plasma in the plasma chamber, wherein the working gas and the nonthermal plasma interact to form an activated gas;
supplying the activated gas to a food treatment zone;
conveying a food product through the food treatment zone such that activated gas contacts a surface of the food product;
conveying the food product through an application region and depositing a composition on the surface of the food product.

2. The method of claim 1, the working gas comprising ambient air.

3. The method of claim 1, wherein the activated gas is supplied to the food treatment zone at a temperature of about 5 degrees Celsius to about 100 degrees Celsius.

4. The method of claim 1, wherein the activated gas is supplied to the food treatment zone at a relative humidity of about 10 to about 100 percent.

5. The method of claim 1, the food product comprising a baked good or a fried good.

6. The method of claim 1, the composition comprising a food grade oil.

7. The method of claim 1, the composition comprising a food seasoning.

8. The method of claim 1, wherein the activated gas is pushed through a plurality of apertures before contacting the surface of the food product.

9. The method of claim 1, wherein the food product is supported by a substrate surface defining a plurality of apertures therein, wherein the activated gas is pushed through the plurality of apertures before contacting the surface of the food product.

10. The method of claim 9, wherein the substrate surface forms part of a conveyor belt.

11. The method of claim 1, wherein the activated gas increases the surface energy of the food product.

12. The method of claim 1, wherein the food treatment zone comprises a fluidized bed.

13. A system for applying a composition to a food product comprising:
an activated gas generator comprising:
a source of a working gas;
a nonthermal plasma generator configured to generate a nonthermal plasma; and
an activated gas formation chamber for contacting the cold plasma with the working gas where an activated gas is formed,
the activated gas formation chamber defining an activated gas outlet;
a food treatment chamber in fluid communication with the activated gas outlet, the food treatment chamber configured to receive a food product for treatment with the activated gas; and
a composition applicator configured to deposit a composition on a surface of the food product after treatment with the activated gas.

14. The system of claim 13, the working gas comprising ambient air.

15. The system of claim 13, the composition comprising a food grade oil and a food seasoning.

16. The system of claim 13, wherein the food product is supported by a substrate surface defining a plurality of apertures therein, wherein the activated gas is pushed through the plurality of apertures before contacting the surface of the food product.

17. The system of claim 16, wherein the substrate is a conveyor belt.

18. The system of claim 13, the food treatment chamber comprising:
a tumbler comprising:
a bulk material inlet for receiving a bulk material to be treated;
a gas inlet in fluid communication with the activated gas generator;
a rotational drum configured to receive the activated gas from the gas inlet at a mixing region of the drum; and
wherein the composition applicator is configured to introduce a composition into the mixing region of the drum.

19. The system of claim 18, the rotational drum comprising a plurality of apertures for receiving activated gas and introducing it to the mixing region.

20. The system of claim 13, the food treatment chamber comprising:
a treatment tunnel in fluid communication with the activated gas generator, the treatment tunnel configured to contain a flow of activated gas;
a conveying mechanism configured to move discrete food items through the flow of activated gas in the treatment tunnel; and
wherein the composition applicator is downstream from the treatment tunnel.
